(19) United States
(12) Patent Application Publication
(10) Pub. No.: US 2025/0008493 A1
(43) Pub. Date: Jan. 2, 2025

(54) SUCCESSIVE APPROXIMATION-BASED JOINT SCHEDULING METHOD FOR TIME SENSITIVE NETWORK AND INDUSTRIAL WIRELESS NETWORK

(71) Applicant: CHONGQING UNIVERSITY OF POSTS AND TELECOMMUNICATIONS, Chongqing (CN)

(72) Inventors: Min WEI, Chongqing (CN); Shujie YANG, Chongqing (CN); Xinyang YU, Chongqing (CN); Tao YU, Chongqing (CN); Seungho HONG, Chongqing (CN)

(73) Assignee: CHONGQING UNIVERSITY OF POSTS AND TELECOMMUNICATIONS, Chongqing (CN)

(21) Appl. No.: 18/709,794

(22) PCT Filed: Apr. 7, 2023
(86) PCT No.: PCT/CN2023/086783

§ 371 Date: May 13, 2024

(30) Foreign Application Priority Data
Jun. 27, 2022 (CN) 202210783436.7

(51) Int. Cl. H04W 72/0446; H04W 40/02; H04W 72/566

(52) U.S. Cl. CPC H04W 72/0446; H04W 40/02; H04W 72/566

(57) ABSTRACT

A successive approximation-based joint scheduling method for a time sensitive network and an industrial wireless network includes: in an offline stage: S1, performing customization processing on a superframe structure in an industrial wireless network, determining a superframe duration and a slot length, and calculating the number of slots; S2, acquiring data packet information sent by a node, wherein the data packet information remains consecutive temporally; S3, constructing a training set and a test set for a slot requirement forecasting model; and S4, training the slot requirement prediction model; and in an online stage: S5, configuring a heterogeneous network, which involves configuring configuration information, which is determined in the off-line stage, for a cooperative scheduling subsystem, an industrial wireless gateway, a wireless routing device and an industrial wireless node; S6, performing slot prediction and assignment, and broadcasting beacons; and S7, performing data transmission according to an allocated path.

### FIELD

The present disclosure relates to the field of industrial wireless network scheduling, and in particular to a successive approximation-based joint scheduling method for a time sensitive network and an industrial wireless network.

### BACKGROUND

An intelligent factory envisioned by Industry 4.0 includes multiple mobile devices. The network for providing communication services for the mobile devices should have high flexibility due to the high flexibility of the mobile devices and should have high determinacy due to the real-time requirements of the industrial control. Therefore, only a network having both flexibility and determinacy can meet the requirements of factory intelligence.

At present, many industrial wireless networks (such as WIA-PA and WirelessHART) have high flexibility and are applied to mobile devices in factories. The wired time sensitive network (TSN) is currently a research hotspot in the industrial network field, which ensures the determinacy of data transmission by using a series of key technologies. An industrial wireless network may be integrated with a time sensitive network, meeting both the requirements of the mobile devices in factories for network flexibility and the requirements of industrial control for network determinacy.

In order to integrate two different networks into a heterogeneous network, it is required to perform joint scheduling on information flows of the heterogeneous network, avoiding problems such as collision and congestion to ensure normal transmission of the information flows. For the heterogeneous network including the time sensitive network and the industrial wireless network, joint scheduling is required to ensure that the heterogeneous network inherits both the flexibility of the industrial wireless network and the determinacy of the time sensitive network.

The joint scheduling is very important in heterogeneous networks but is not well developed. Currently the research mainly focuses on a heterogeneous network including a single time sensitive network and a single industrial wireless network. However, some smart factories use mobile devices in charge of different areas that are far apart. Therefore, the heterogeneous network applied to such smart factories should meet requirements of communications between different areas that are far apart. Apparently, the heterogeneous network according to the conventional research cannot meet the requirements.

### SUMMARY

In view of this, a successive approximation-based joint scheduling method for a time sensitive network and an industrial wireless network is provided according to the present disclosure, so as to achieve connecting two industrial wireless networks by a time sensitive network to cover a large area, and ensuring that the heterogeneous network inherits both the flexibility of the industrial wireless network and the determinacy of the time sensitive network.

To achieve the above objectives, the following technical solutions are provided according to the present disclosure.

According to the present disclosure, a successive approximation-based joint scheduling method for a time sensitive network and an industrial wireless network is provided. The method is applied to a heterogeneous network scheduling architecture for a time sensitive network and an industrial wireless network. The heterogeneous network scheduling architecture includes a user plane, a control plane, and a data plane. The user plane includes a user plane APP, which is used to provide a user with visualized data and options (where the user may obtain the state of the entire network based on the data and may issue commands to the network based on the options). The control plane includes an industrial software defined controller (ISDC) and two industrial network system managers, which are used to collect information from the data plane and perform joint scheduling on the heterogeneous network. The industrial software defined controller (ISDC) includes a collaborative scheduling subsystem, a northbound interface, a southbound interface, and an east-west interface. The collaborative scheduling subsystem used to perform calculation on state data of the network to obtain a final scheduling plan. The northbound interface is used to communicate with the user plane to send network state information or receive the user's commands. The southbound interface is used to communicate with the CNC configuration interface of the data plane to obtain state data of the time sensitive network and distribute the scheduling plan to the time sensitive network. In addition, the southbound interface is used to communicate with an industrial wireless gateway in the data plane to distribute the scheduling plan to the industrial wireless networks. The east-west interface is used to communicate with the industrial network system managers to obtain state data of the industrial wireless networks. Each industrial network system manager manages an industrial wireless network connected to the respective industrial network system manager. The collaborative scheduling interface of each industrial network system manager is used to communicate with the industrial wireless gateway in the data plane to obtain the state data of the industrial wireless network. The data plane includes a time sensitive network and two industrial wireless networks, which connect nodes, routers, gateways, and other devices and provide paths for data transmission. The time sensitive network is arranged at the center of the entire heterogeneous network, and transmits data sent by one industrial wireless network to the other industrial wireless network based on a deterministic requirement. Each of the two industrial wireless networks respectively collects data and sends data, which is required to be responded by the other industrial wireless network, to the time sensitive network through an industrial wireless gateway.

In addition, a mapping relationship between priorities of WIA-PA data and priorities of data streams of the time sensitive network is determined, as shown in the following Table 1:

TABLE 1

| WIA-PA data | Priorities after converting |
|---|---|
| frame type | to TSN data stream |
| beacon frame | 7 |
| data frame | [0, 6] |

In the above mapping relationship table, the beacon frame carries network control information for controlling assignment of network time slots, so that the TSN data stream converted from the beacon frame is assigned with a highest priority of 7; and the data frame carries various types of information (such as temperature and humidity information) sent by various devices in a factory, so that the TSN data stream converted from the data frame is assigned with a priority within a range of [0, 6]. Due to that different data frames carry different types of information, it is required to further determine the priorities of the data frames. The user determines scores for urgency levels corresponding to various types of information, and then the priorities of the data frames are determined based on the following Rule 1:
if

$${Score}_{min} + \frac{( {Score}_{max} - {Score}_{min} )}{7} * n \leq Score < {Score}_{min} + \frac{( {Score}_{max} - {Score}_{min} )}{7} * ( n + 1 ) ,$$

the priority is equal to n+1; and
   if Score=Scoreₘₐₓ, the priority is equal to 6

### Rule 1

In the above Rule 1, Scoreₘᵢₙ represents a lowest score for an urgency level determined by the user for various types of information, Scoreₘₐₓ represents a highest score for the urgency level determined by the user for the various types of information, and Score represents a score for an urgency level determined by the user for a type of information.

The mapping relationship table is used as follows.

In a case that WIA-PA data is inputted to the TSN from the WIA-PA side, the industrial wireless gateway determines a WIA-PA data frame as a payload of a TSN data frame, encapsulates the WIA-PA data frame, and converts the WIA-PA data frame to a TSN data frame. Based on the type of the WIA-PA data and a score of the urgency level, the industrial wireless gateway obtains a priority of the data in the TSN by using the mapping relationship table. Then, the industrial wireless gateway configures a priority code point in the TSN data frame to a code corresponding to the priority. Thus, the conversion of the WIA-PA data frame to the TSN data frame and the mapping of priority are performed.

In a case that TSN data is inputted to the WIA-PA from the TSN side, the industrial wireless gateway removes all other parts than the payload from the TSN data frame, and the remaining payload is the WIA-PA data frame. Thus, the conversion of the TSN data frame to the WIA-PA data frame and the mapping of priority are performed. Based on the above processes, a successive approximation-based joint scheduling method for a time sensitive network and an industrial wireless network is provided according to the present disclosure. The method includes:
in an offline stage:
   S1: customizing a superframe structure in the industrial wireless network, obtaining, from a user, a time period of the superframe and a time period of a time slot, and calculating the number of the time slot;
   S2: obtaining, from the user, data packet information sent by a node, where the data packet information is continuous over time;
   S3: obtaining, from the user, a training set and a testing set for a time slot requirement prediction model; and
   S4: training the time slot requirement prediction model; and in an online stage:
   S5: configuring a heterogeneous network, where a collaborative scheduling subsystem, an industrial wireless gateway, a wireless routing device and an industrial wireless node are configured with configuration information determined in the offline phase;
   S6: performing time slot prediction, time slot assignment, and beacon broadcasting; and
   S7: each of nodes in the industrial wireless network transmits data through an assigned path.

In an embodiment, the customizing a superframe structure in S1 includes a beacon broadcasting stage and a data transmission stage. In the beacon broadcasting stage, the collaborative scheduling subsystem predicts time slot requirements of nodes in a next superframe by using the time slot requirement prediction model and assigns time slots of the next superframe based on a prediction result, and then the industrial wireless gateway broadcasts a beacon frame to the industrial wireless network, where the beacon frame includes a time slot assignment table of the next superframe. In the data transmission stage, the time slots are classified based on the time slot assignment table included in the beacon frame, the time slots are classified into periodic data time slots, non-periodic data time slots, and idle time slots, the periodic data time slots are assigned to a node required to upload periodic data, the non-periodic data time slots are assigned to a node determined by the time slot requirement prediction model that is required to upload non-periodic data, and the idle time slots are all other time slots than the periodic data slots and the non-periodic data slots.

In an embodiment, the time period of the superframe in S1 is determined by: obtaining, from the user, service requirements of an industrial site to determine nodes required to upload periodic data, obtaining, from the user, time periods of the nodes uploading data, and determining a least common multiple of the time periods as the time period of the superframe by using the following equation:

$${T}_{superframe} = l c m ( {T}_{1} , {T}_{2} , … , {T}_{n} )$$

where T_{superframe} represents the time period of the superframe, T₁, T₂, ⋅ ⋅ ⋅ , Tₙ represent time periods required by respective n nodes to upload periodic data, and lcm represents the least common multiple; and
the time period of the time slot is determined by: calculating the time period of the time slot based on lengths of paths in the network by using the following equation, where the time period of the time slot is positively correlated with a length of a longest path in the network:

$${T}_{slot} = ( max ( {Length}_{1} , {Length}_{2} , … , {Length}_{n} ) + 2 ) * {T}_{h o p}$$

where Tₛₗₒₜ represents the time period of the time slot, Length₁, Length₂, ⋅ ⋅ ⋅ , Lengthₙ, represent lengths of respective n paths in the network, max represents a maximum value operation, and Tₕₒₚ represents an average time period required for a data packet to pass through a hop.

In an embodiment, the constructing a training set and a testing set in S3 includes:
S31: extracting data sets, where all collected data packets are extract into superframes, information of data packets in each of the superframes form a data set, a difference between a timestamp of the first data packet in a data set and a timestamp of the first data packet in a subsequent data set is equal to the time period of the superframe, and a front-closed and back-open interval between the timestamp of the first data packet in the data set and the timestamp of the first data packet in the subsequent data set are extracted to a data set;
S32: supplementing information in the data sets, where missed information for multiple time slots in the data sets is supplemented, information in a single data set is a m*n matrix, m represents the number of time slots in a single superframe, n represents the number of industrial wireless nodes in a heterogeneous network, each element in the matrix has a numerical value that represents a priority of data sent by an industrial wireless node in a time slot of a current superframe, and in the data set information matrix, 0 is filled for idle time slots to indicate that no node sends data in the idle time slots; and
S33: grouping the data sets, where for data sets with a scale of millions or less, 60% of the data sets are grouped to training sets, 20% of the data sets are grouped to validation sets, and 20% of the data sets are grouped to testing sets; and for data sets with a scale of millions or more, 98% of the data sets are grouped to training sets, 1% of the data sets are grouped to validation sets, and 1% of the data sets are grouped to testing sets.

In an embodiment, the training the time slot requirement prediction model in S4 includes:
inputting an m*n matrix from the training set;
outputting an m*n matrix, where each of elements in the matrix includes a numerical value and a percentage, the numerical value represents a priority of data sent by an industrial wireless node in a time slot of a next superframe predicted by the model, and the percentage represents a probability of the node sending data in the time slot;
performing error calculation by using the following equation:

$$E = \frac{1}{2} {\sum }_{i = 1}^{m} {\sum }_{j = 1}^{n} {( {Real}_{i , j} - {Forecast}_{i , j} * {Percent}_{i , j} )}^{2}$$

where E represents an error of a prediction, m represents the number of time slots in a single superframe, n represents the number of the industrial wireless node, Real_{i,j} represents a priority of data sent by a j-th node in an i-th time slot of the next superframe in an actual measurement, Forecast_{i,j} represents a priority of data sent by the j-th node in the i-th time slot of the next superframe in the prediction, and Percent_{i,j} represents a probability of the j-th node sending data in the i-th time slot of the next superframe in the prediction;
performing validation based on a predetermined validation set by using a k-fold cross validation algorithm;
performing performance analysis on the model, where the model is tested using data sets in the training set to obtain error values, and an average error is obtained by using the following equation:

$$\overline{E} = \frac{{\sum }_{k = 1}^{q} {E}_{k}}{q}$$

where Ē represents the average error, q represents the number of the data sets in the testing set, and Eₖ represents an error obtained by testing the model with a k-th data set in the training set;
calculating an error reference value by using the following equation:

$$\overline{Goal} = \frac{\frac{1}{2} {\sum }_{k = 1}^{p} {\sum }_{i = 1}^{m} {\sum }_{j = 1}^{n} {Real}_{k , i , j}^{2}}{k}$$

where G̅o̅a̅l̅ represents the error reference value, p represents the total number of the data sets, m represents the number of the time slots in the single superframe, n represents the number of the industrial wireless nodes, and Real_{k,i,j} represents a priority of data sent by a j-th node in an i-th time slot of a k-th data set in actual measurement;
comparing the average error value with the error reference value by using the following formulas to determine whether the model is qualified:

$$\begin{matrix}\begin{matrix}0 \leq \overline{E} < \overline{Goal} * 1 \% , & qualified\end{matrix} \\ \begin{matrix}\overline{Goal} * 1 \% \leq \overline{E} \leq \overline{Goal} * 1 \% , & not qualified\end{matrix}\end{matrix}$$

performing comparison, by the user, using the above formulas; continuing the training in a case that the model is not qualified; and calculating an average network transmission delay predicted by the model using the following equation in a case that the model is qualified:

$$\overline{{T}_{idle}} = \frac{{\sum }_{k = 1}^{p} {\sum }_{i = 1}^{m} {T}_{slot}}{p}$$

where T̅_̅{̅i̅d̅l̅e̅}̅ represents an average time period of an idle time slot in the single superframe, p represents the total number of the data sets, m represents the number of the idle time slots in the single superframe, and Tₛₗₒₜ represents the time period of the time slot;

$$\overline{delay} = ( 1 - \frac{\overline{E}}{\overline{Goal}} * {T}_{s l o t} ) + ( \frac{\overline{E}}{\overline{Goal}} * ( 1 - \frac{\overline{{T}_{idle}}}{{T}_{superframe}} ) * \frac{{T}_{superframe}}{\overline{{T}_{idle}}} * {T}_{s l o t} )$$

where d̅e̅l̅a̅y̅ represents an average delay, and 7 Superframe represents the time period of the superframe;
where the average network transmission delay and a required average delay is compared by using the following formulas to determine whether the average network transmission delay predicted by the model is qualified, the training is continued in the case that the model is not qualified, and the training is ended and the online stage is entered in the case that the model is qualified:

$$\begin{matrix}\begin{matrix}0 \leq \overline{delay} \leq {delay}_{require} , & qualified\end{matrix} \\ \begin{matrix}\overline{delay} > {delay}_{require} , & not qualified\end{matrix}\end{matrix}$$

where delay_{require} represents the required average delay inputted by the user.

In an embodiment, S5 includes configuring the collaborative scheduling subsystem with the time period of the superframe, the time period of the time slot, a priority relationship mapping table, a network path information table, and the time slot requirement prediction model, and configuring all industrial wireless gateways, wireless routing devices, and industrial wireless nodes in the industrial wireless network with the time period of the superframe, the time period of the time slot, the priority relationship mapping table, and the network path information table.

In an embodiment, in S6, after a current superframe ends and before a next superframe starts, the collaborative scheduling subsystem inputs data packet information of the current superframe to the time slot requirement prediction model to output time slot requirement prediction information of the next superframe, and assigns time slots sequentially; a node with a probability greater than thresholdₚₑᵣ of transmitting data in a time slot is assigned with the time slot, a node with a probability less than thresholdₚₑᵣ of transmitting data in a time slot is not assigned with the time slot, wherein time slot assignment results are written in a time slot assignment table; and after the time slots are assigned, the industrial wireless gateway writes the time slot assignment table in a beacon frame, the beacon frame is broadcasted to all industrial wireless nodes in the industrial wireless network during beacon broadcasting, to update the time slot assignment table in all the industrial wireless nodes, and in the next superframe, the industrial wireless nodes communicate with each other based on the updated time slot assignment table.

In an embodiment, the data transmitted in step S7 includes command data sent by the user and data sent by a node. The command data sent by the user is not assigned with a time slot but has a highest priority, and is directly transmitted through a shortest path selected from paths in the network. The data sent by the node is transmitted by:
S71: determining, by a router, whether the node sending the data is assigned with a time slot;
   in a case that the node sending the data is assigned with a time slot, proceed to S72; and
   in a case that the node sending the data is not assigned with a time slot, determining whether a current time slot is an idle time slot;
      in a case that the current time slot is an idle time slot, proceeding to S72; and
      in a case that the current time slot is not an idle time slot, determining whether a priority of the data sent by the node is higher than priorities of data sent by other nodes assigned with the time slot;
         in a case that the priority of the data sent by the node is higher than the priorities of the data sent by the other nodes assigned with the time slot, proceeding to S72; and
         in a case that the priority of the data sent by the node is not higher than the priorities of the data sent by the other nodes assigned with the time slot, the node waits until a next idle time slot begins;
S72: sending, by the node, data to a route directly connected to the node;
S73: determining, by the router, whether there are any remaining paths in a path occupancy table;
   in a case that there are any remaining paths in the path occupancy table, assigning a shortest path in the remaining paths to the node, updating the path occupancy table, and transmitting the data; and
   in a case that there are no remaining paths in the path occupancy table, proceeding to S74;
S74: sorting, by the router, occupied paths in the path occupancy table based on priorities of data occupying the paths;
S75: comparing, by the router, a priority of data occupying a current path with the priority of the data sent by the node;
   in a case that the priority of the data sent by the node is higher than the priority of the data occupying the current path, sharing the current path between the data sent by the node and the data being compared, updating, by the router, the path occupancy table, and transmitting the data; and
   in a case that the priority of the data sent by the node is not higher than the priority of the data occupying the current path, checking, by the router, a next path in the path occupancy table, and proceeding to S74; and
S76: transmitting the data after a path is successfully assigned, where after data sent by a node reaches an industrial wireless gateway of the industrial wireless network, the industrial wireless gateway sends the transmission information of the data to the collaborative scheduling subsystem, and the collaborative scheduling subsystem adds the transmission information to a data set to be used as an input to the time slot requirement prediction model for a next superframe.

In an embodiment, the path occupancy table is used by the wireless routing device to record occupancy situations of all paths from the wireless routing device to the other nodes and an industrial software defined controller. The path occupancy table includes the number of a path, a destination node of the path, details of the path, a length of the path, a quantity and a priority of data occupying the path. The path occupancy table is initialized in configuring the heterogeneous network in the online stage. The wireless routing device selects all the paths from the wireless routing device to the nodes and the industrial software defined controller based on a configured network path information table, fills in a destination node column based on the network path information table, and fills a priority of data occupying the path with 0. A column of priority of data occupying the path in the path occupancy table is filled with 0 at a beginning of a superframe, and is updated every time when a path is occupied for sending data in a data transmission stage.

The beneficial effect of the present disclosure is that two industrial wireless networks are connected by using a time sensitive network to cover a large area, and it is ensured that the heterogeneous network inherits both the flexibility of the industrial wireless network and the determinacy of the time sensitive network.

The other advantages, objectives, and features of the present disclosure are to be described in the subsequent specification. To some extent, the other advantages, objectives, and features of the present disclosure are apparent to those skilled in the art in view of the following description, or may be taught from the practice of the technical solutions in the present disclosure. The objectives and other advantages of the present disclosure may be achieved and obtained via embodiments described below.

### BRIEF DESCRIPTION OF THE DRAWINGS

In order to make the purpose, technical solutions, and advantages of the present disclosure clearer, a detailed description of preferred embodiments of the present disclosure are provided below in conjunction with the accompanying drawings. In the drawings:

FIG. 1 is a schematic diagram showing a scheduling architecture for a heterogeneous network of a time sensitive network and industrial wireless networks;

FIG. 2 is a flowchart of a successive approximation-based joint scheduling method for a time sensitive network and an industrial wireless network;

FIG. 3 is a schematic diagram showing a structure of a customized superframe;

FIG. 4 is a schematic diagram of extracting a data set; and

FIG. 5 is a flowchart of assigning a path to a node for sending data.

### DETAILED DESCRIPTION OF THE EMBODIMENTS

Hereinafter, the implementation of the present disclosure is illustrated based on specific embodiments. Those skilled in the art may easily understand the other advantages and benefits of the present disclosure from the content disclosed in this specification. The present disclosure may also be implemented or applied through different specific embodiments, and the details in this specification may be improved or modified based on different perspectives and applications without departing from the spirit of the present disclosure. It should be noted that the illustrations provided in the following embodiments only illustrate the basic concept of the present disclosure. Without conflict, the following embodiments and the features in the embodiments may be combined with each other.

The accompanying drawings are only used for illustrative purposes and show only schematic diagrams not physical images, which should not be understood as a limitation to the present disclosure. In order to better illustrate the embodiments of the present disclosure, some components in the drawings may be omitted, enlarged or reduced, which do not represent actual sizes of a product. For those skilled in the art, it is understandable that some well-known structures and explanations of these structures in the drawings may be omitted.

The same or similar symbols in the drawings of the embodiments of the present disclosure correspond to the same or similar components. In the description of the present disclosure, it should be understood that the terms, such as “up”, “down”, “left”, “right”, “front” and “back”, indicate orientation or positional relationships based on the orientation or positional relationships shown in the drawings, which are only for the convenience of describing and not for indicating or implying that the device or components referred to must have a specific orientation, be constructed and operated in a specific orientation. Therefore, the terms used to describe the positional relationship in the attached drawings are only for illustrative purposes and cannot be understood as a limitation of the present disclosure. Those skilled in the art can understand the specific meanings of the above terms based on specific situations.

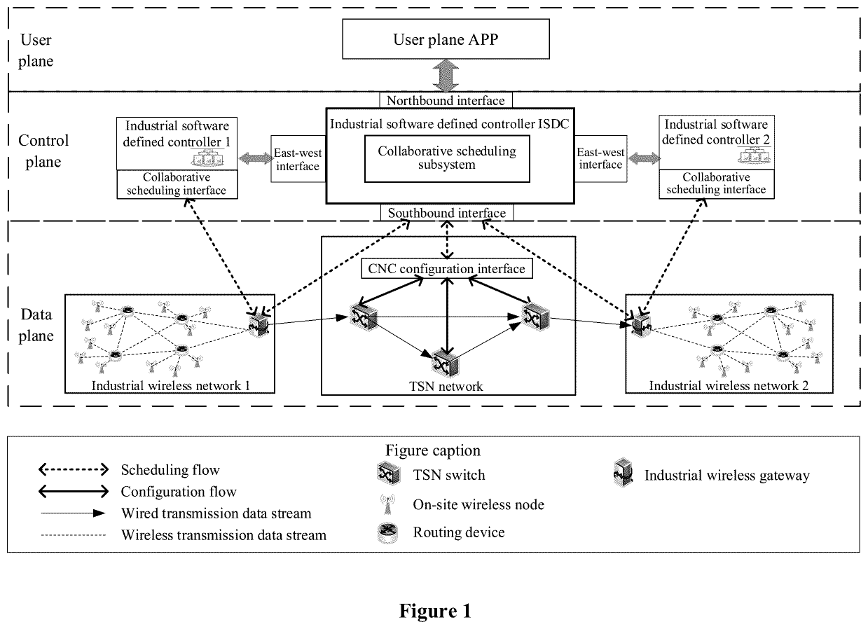

The joint scheduling method according to the present disclosure is applied to a heterogeneous network of a time sensitive network and an industrial wireless network. As shown in FIG. 1, the heterogeneous network scheduling architecture includes a user plane, a control plane, and a data plane.

The user plane includes a user plane APP, which is used to provide a user with visualized data and options (where the user may obtain the state of the entire network based on the data and may issue commands to the network based on the options).

The control plane includes an industrial software defined controller (ISDC) and two industrial network system managers, which are used to collect information from the data plane and perform joint scheduling on the heterogeneous network. The industrial software defined controller (ISDC) includes a collaborative scheduling subsystem, a northbound interface, a southbound interface, and an east-west interface. The collaborative scheduling subsystem is used to perform calculation on state data of the network to obtain a final scheduling plan. The northbound interface is used to communicate with the user plane to send network state information or receive the user's commands. The southbound interface is used to communicate with the CNC configuration interface of the data plane to obtain state data of the time sensitive network and distribute the scheduling plan to the time sensitive network. In addition, the southbound interface is used to communicate with an industrial wireless gateway in the data plane to distribute the scheduling plan to the industrial wireless networks. The east-west interface is used to communicate with the industrial network system managers to obtain state data of the industrial wireless networks. Each industrial network system manager manages an industrial wireless network connected to the respective industrial network system manager. The collaborative scheduling interface of each industrial network system manager is used to communicate with the industrial wireless gateway in the data plane to obtain the state data of the industrial wireless network.

The data plane includes a time sensitive network and two industrial wireless networks, which connect nodes, routers, gateways, and other devices and provide paths for data transmission. The time sensitive network is arranged at the center of the entire heterogeneous network, and transmits data sent by one industrial wireless network to the other industrial wireless network based on a deterministic requirement. Each of the two industrial wireless networks respectively collects data and sends data, which is required to be responded by the other industrial wireless network, to the time sensitive network through an industrial wireless gateway.

The WIA-PA network data link sub-layer data unit defines data streams with four priorities, including command data with a first priority, process data with a second priority, general data with a third priority, and non-emergency alarm data with a fourth priority. The WIA-PA network application layer defines three data stream transmission modes. The time sensitive network defines data streams with eight priorities.

To transmit data streams between the WIA-PA network and the time sensitive network, it is required to determine a mapping relationship between priorities of WIA-PA data and priorities of data streams of the time sensitive network.

The mapping relationship between the data streams of the WIA-PA network and the data streams of the time sensitive network is shown in the following Table 1:

TABLE 1

| WIA-PA data | Priorities after converting |
|---|---|
| frame type | to TSN data stream |
| beacon frame | 7 |
| data frame | [0, 6] |

In the above mapping relationship table, the beacon frame carries network control information for controlling assignment of network time slots, so that the TSN data stream converted from the beacon frame is assigned with a highest priority of 7; and the data frame carries various types of information (such as temperature and humidity information) sent by various devices in a factory, so that the TSN data stream converted from the data frame is assigned with a priority within a range of [0, 6]. Due to that different data frames carry different types of information, it is required to further determine the priorities of the data frames. The user determines scores for urgency levels corresponding to various types of information, and then the priorities of the data frames are determined based on the following Rule 1:
if

$${Score}_{min} + \frac{( {Score}_{max} - {Score}_{min} )}{7} * n \leq Score < {Score}_{min} + \frac{( {Score}_{max} - {Score}_{min} )}{7} * ( n + 1 ) ,$$

the priority is equal to n+1; and
   if Score=Scoreₘₐₓ, the priority is equal to 6

### Rule 1

In the above Rule 1, Scoreₘᵢₙ represents a lowest score for an urgency level determined by the user for various types of information, Scoreₘₐₓ represents a highest score for the urgency level determined by the user for the various types of information, and Score represents a score for an urgency level determined by the user for a type of information.

The mapping relationship table is used as follows.

In a case that WIA-PA data is inputted to the TSN from the WIA-PA side, the industrial wireless gateway determines a WIA-PA data frame as a payload of a TSN data frame, encapsulates the WIA-PA data frame, and converts the WIA-PA data frame to a TSN data frame. Based on the type of the WIA-PA data and a score of the urgency level, the industrial wireless gateway obtains a priority of the data in the TSN by using the mapping relationship table. Then, the industrial wireless gateway configures a Priority Code Point in the TSN data frame to a code corresponding to the priority. Thus, the conversion of the WIA-PA data frame to the TSN data frame and the mapping of priority are performed.

In a case that TSN data is inputted to the WIA-PA from the TSN side, the industrial wireless gateway removes all other parts than the payload from the TSN data frame, and the remaining payload is the WIA-PA data frame. Thus, the conversion of the TSN data frame to the WIA-PA data frame and the mapping of priority are performed.

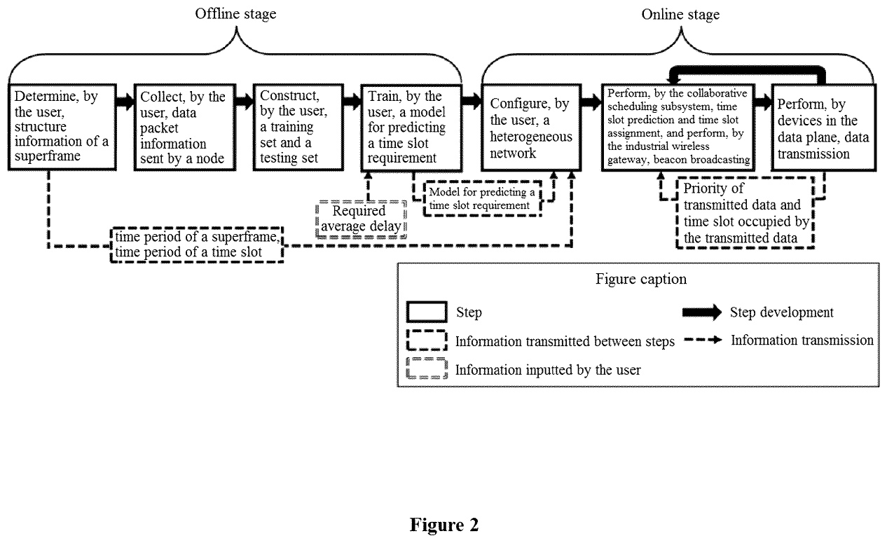

According to the present disclosure, a successive approximation-based joint scheduling method for a time sensitive network and an industrial wireless network is provided to solve the problem of how to assign time slots in a heterogeneous network. FIG. 2 shows the steps of the method.

In the offline stage, the following four steps are performed.

In a first step, superframe structure information is determined.

A superframe structure is customized.

In the present disclosure, the superframe structure in the industrial wireless network is customized. Before introducing the customized superframe structure, two types of data that exist in an industrial field network are described as below.

(1) A first type of data is periodic data. In a factory, the user needs to periodically obtain states of some devices, so that some nodes are required to upload detected data according to a predetermined time period. The first type of data is considered in the present disclosure.

(2) A second type of data is non-periodic data. In the factory, in a case that the user needs to temporarily obtain a current state of a device or command a device to perform an operation, or in a case that a physical value (such as a solution temperature in a chemical factory) monitored by a node reaches a threshold and then it is required to notify another device to perform an operation, non-periodic data is generated. The second type of data is considered in the present disclosure.

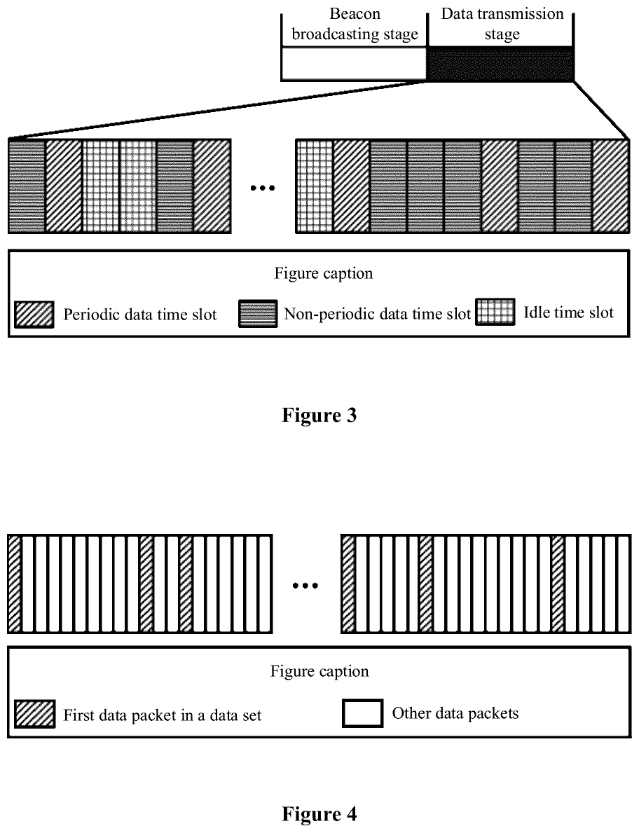

Considering the requirement for scheduling the above two types of data, the superframe structure in the industrial wireless network is customized as shown in FIG. 3.

As shown in FIG. 3, the process of customizing a superframe structure includes a beacon broadcasting stage and a data transmission stage, and the following operations are performed.

(1) In the beacon broadcasting stage, the collaborative scheduling subsystem predicts time slot requirements of nodes in a next superframe by using a time slot requirement prediction model which is to be described below, and assigns time slots of the next superframe based on a prediction result. Then, the industrial wireless gateway broadcasts a beacon frame to the industrial wireless network, where the beacon frame includes a time slot assignment table of the next superframe.

(2) In the data transmission stage, the time slots are classified based on the time slot assignment table included in the beacon frame. The time slots are classified into periodic data time slots, non-periodic data time slots, and idle time slots. The periodic data time slots are assigned to a node having a requirement for uploading periodic data, the non-periodic data time slots are assigned to a node determined by the time slot requirement prediction model that has a requirement for uploading non-periodic data, and the idle time slots are all other time slots than the periodic data slots and the non-periodic data slots.

Since the time slot assignment in the industrial wireless network is performed based on the customized superframe, the method determines the superframe structure information before performing scheduling, including determining a time period of the superframe and determining a time period of a time slot. In performing time slot assignment in the industrial wireless network, another important parameter is the number of time slots in a superframe. In the present disclosure, the number of time slots in a superframe is not studied because the number of time slots can be calculated using the following formula (1) after determining the time period of the superframe and the time period of the time slot:

$$N u {m}_{slot} = \frac{{T}_{superframe}}{{T}_{slot}} \qquad ( 1 )$$

where Numₛₗₒₜ represents the number of time slots in a superframe, T_{superframe} represents the time period of the superframe, and Tₛₗₒₜ represents the time period of the time slot.

The time period of the superframe is determined as below.

In order to improve the predictability of time slot assignment and reduce the difficulty of scheduling, it is ensured in the present disclosure that the distribution of time slots occupied by uploading periodic data is consistent in each superframe. Therefore, each of the nodes required to upload periodic data should perform at least one data uploading in a single superframe.

Therefore, service requirements of an industrial site (for example, it is required to regularly upload a temperature data of a reactor in a chemical plant) is first obtained to determine the nodes required to upload periodic data, and determine time periods of the nodes uploading data, and then a least common multiple of the time periods is determined as the time period of the superframe, as the following formula (2):

$${T}_{superframe} = l c m ( {T}_{1} , {T}_{2} , … , {T}_{n} ) \qquad ( 2 )$$

where T_{superframe} represents the time period of the superframe, and T₁, T₂, ⋅ ⋅ ⋅ , Tₙ represent time periods of n nodes required to upload periodic data.

The time period of the time slot is determined as below.

In order to ensure that the time period of a time slot is sufficient for transmitting a data packet from a sender to a receiver, the time period of a time slot is equal to a time period required for transmitting a data packet through a path having a maximum length (where the length refers to the number of hops rather than a spatial distance) in a network.

Based on the above description, it can be seen that the time period of the time slot is positively correlated with the length of the longest path in the network. Therefore, a network path information table (the network path does not include the loopback paths in the network), as shown in the following Table 2, is established based on the network structure of the constructed network.

TABLE 2

| Path number | Detailed path | Path length |
|---|---|---|
| 1 | IWNR_{1, 1} _{→} IWNS₁ _{→} TSNᵢ _{→} | 5 |
| | IWNS₂ _{→} IWNR_{2, 1} | |
| 2 | IWNR_{1, 1} _{→} IWNS₁ _{→} TSNᵢ _{→} | 5 |
| | IWNS₂ _{→} IWNR_{2, 2} | |
| . . . | . . . | . . . |
| n | IWNR_{i, j} _{→} IWNSᵢ _{→} TSNᵢ _{→} ISDC | 4 |

where IWNᵢ represents an i-th industrial wireless network, IWNSᵢ represents an industrial wireless gateway of the i-th industrial wireless network, IWNRᵢ, represents a j-th routing device in the i-th industrial wireless network, TSNᵢ represents an i-th time sensitive network switch, ISDC represents an industrial software defined controller, and → represents a single hop path from one device to another device.

The time period of the time slot is calculated based on lengths of paths in the network shown in Table 2 by using the following formula (3):

$${T}_{slot} = ( max ( {Length}_{1} , L e n g t {h}_{2} , … , {Length}_{n} ) + 2 ) * {T}_{h o p} \qquad ( 3 )$$

where Tₛₗₒₜ represents the time period of the time slot, and Length₁, Length₂, ⋅ ⋅ ⋅ , Lengthₙ represent path lengths of all n paths in the network. The starting point in Table 3 does not include the industrial wireless node. However, in calculating a transmission time period of a data packet in the network, it is required to consider the time period in which the data packet is transmitted from the industrial wireless node to the wireless routing device. Therefore, max (Length₁, Length₂, L, Lengthₙ) is added with 2. Tₕₒₚ represents an average time period required by a data packet to pass through a hop.

In a second step, data packet information sent by a node is collected.

Since the model used for predicting time slot requirements in the present disclosure is constructed based on a LSTM (long short-term memory) neural network, data packet information are collected and then a training set and a testing set are constructed for the LSTM neural network based on the collected data packet information.

Since the collected data packet information is only used for predicting the time instants for sending data by the industrial wireless nodes, the industrial wireless nodes in the network only need to send data packets according to the business requirements but not need to forward and receive these data packets.

The model for predicting the time slot requirements according to the present disclosure is applied to predict, based on occupancy of time slots in a current superframe, a time slot requirement in an adjacent next superframe. Therefore, the collected data is continuous over time to ensure the accuracy of model training.

The data packets are collected by using a wireless network data packet capture tool, and various information of the data packets is recorded with the following Table 3, where the timestamp, source node, and data stream type are directly obtained from the collected data packets, and the priority is obtained by using the mapping relationship table shown in Table 1 based on the data stream type.

TABLE 3

| Data packet | | Source | Data stream | |
|---|---|---|---|---|
| serial number | Timestamp | node | type | Priority |
| 1 | 0.000000 | IWNN_{1, 1, 1} | command data | 7 |
| 2 | 0.001000 | IWNN_{1, 1, 2} | process data | 6 |
| | | | in P/S mode | |
| . . . | . . . | . . . | . . . | . . . |
| n | 5.003000 | IWNN_{2, 1, 2} | general data | 3 |
| | | | in P/S mode | |

In a third step, a training set and a testing set are constructed.

Data sets are extracted as below.

In an application scenario of the model for predicting the time slot requirements according to the present disclosure, based on occupancy of time slots in a current superframe, a time slot requirement in an adjacent next superframe is predicted. That is, the model performs calculation with a unit of an entire superframe. Therefore, all the collected data packets should be extracted to the superframes, and the information of data packets in each of the superframes form a data set. FIG. 4 is a schematic diagram of performing data set extraction.

As shown in FIG. 4, a difference between a timestamp of the first data packet in a data set and a timestamp of the first data packet in a subsequent data set is equal to the time period of the superframe, so that a front-closed and back-open interval between the timestamps of the first data packet in the data set and the timestamp of the first data packet in the subsequent data set are extracted to a data set. It should be noted that the numbers of data packets in the data sets may not be identical because the data sets are obtained based on the time period of the superframe and the timestamps of the data packets rather than the number of the data packets.

Information is supplemented to the data sets as below.

The above data set extraction is only to convert the collected original data (that is, the data packets sent by the industrial wireless network nodes) to several data sets. However, as mentioned above, the numbers of the data packets in the data sets may be not identical after performing data set extraction. That is, not all the time slots in each of the data sets are occupied by the transmitted data packets, and the unoccupied time slots are idle time slots.

For the LSTM neural network, the expected input should be in a consistent format. However, the information in many time slots in the extracted data sets may be incomplete. Therefore, it is required to supplement the information, so that the information in each of the data sets ultimately has the structure shown in the following Table 4:

TABLE 4

| | IWNN_{1, 1, 1} | IWNN_{1, 1, 2} | . . . | IWNN_{i, j, k} |
|---|---|---|---|---|
| time slot 1 | 1 | 2 | . . . | 4 |
| time slot 2 | 4 | 5 | . . . | 7 |
| . . . | . . . | . . . | . . . | . . . |
| time slot m | 5 | 6 | . . . | 2 |

In the above Table 4, IWNN_{i,j,k} represents a k-th on-site wireless node mounted to a j-th routing device in an i-th industrial wireless network.

Information in a single data set is a m*n matrix (where m represents the number of time slots in a single superframe, n represents the number of industrial wireless nodes in a heterogeneous network). Each of elements in the data set has a numerical value that represents a priority of data sent by an industrial wireless node in a time slot of a current superframe (if the numerical value is equal to 0, it indicates that the node does not send data in the time slot). Taking the value of the element in the first line and second column of the matrix shown in Table 4 as an example (the values in Table 4 are only for illustration but not exact values in practices), the value is equal to 2, which indicates that a second node mounted on a first routing device in a first industrial wireless network sends a data packet having a priority of 2 in a second time slot of the current superframe.

Based on the above information structure in a single data set, it can be seen that the information in the data sets is supplemented by filling 0 for an idle time slot in the data set information matrix, indicating that no node sends data in the idle time slot.

The data sets are grouped as below.

According to the scales of the data sets, the data sets are grouped in the following two ways. Referring to normal grouping rules of the neural network data sets, the data sets are grouped in different proportions.

For small-scale sample sets (with a scale of tens of thousands), 60% of the data sets are grouped to training sets, 20% of the data sets are grouped to validation sets, and 20% of the data sets are grouped to testing sets.

For large-scale sample sets (with a scale of tens of millions or more), 98% of the data sets are grouped to training sets, 1% of the data sets are grouped to validation sets, and 1% of the data sets are grouped to testing sets.

In a fourth step, the time slot requirement prediction model is trained.

The time slot requirement prediction model is trained based on an LSTM neural network. A detailed explanation of the training process is described below.

For an input layer, the input data is an m*n matrix as shown in Table 5, and the meaning of the matrix are described in the third step in the offline stage.

For an output layer, the output data is an m*n matrix as shown in Table 5 (where m and n have the same meaning as the input data). Each of elements in the matrix includes a numerical value and a percentage. The numerical value represents a priority of data sent by an industrial wireless node in a time slot of a next superframe predicted by the model (if the numerical value is equal to 0, it indicates that the node does not send data in the time slot). The percentage represents a probability of the node sending data in the time slot (where a sum of possibilities of different nodes in a same time slot is 1). Taking the element in the first line and second column of the matrix shown in Table 5 as an example (the numerical values and the percentages in Table 5 are set only for illustration and are not exact numerical values and percentages in practices), the numerical value is 2 and the percentage is 90%, indicating that the model predicts that a second node mounted on a first routing device in a first industrial wireless network sends a data packet with a priority of 2 in a second time slot of a next superframe, and the probability thereof is 90%.

TABLE 5

| | IWNN_{1, 1, 1} | IWNN_{1, 1, 2} | . . . | IWNN_{i, j, k} |
|---|---|---|---|---|
| time slot 1 | 1.2% | 2.90% | . . . | 0.0% |
| time slot 2 | 1.3% | 0.0% | . . . | 7.90% |
| . . . | . . . | . . . | . . . | . . . |
| time slot m | 3.90% | 0.0% | . . . | 4.10% |

Error calculation is performed by using the following formula (4):

$$E = \frac{1}{2} {\sum }_{i = 1}^{m} {\sum }_{j = 1}^{n} {( {Real}_{i , j} - {Forecast}_{i , j} * {Percent}_{i , j} )}^{2} \qquad ( 4 )$$

where E represents an error of a prediction, m represents the number of time slots in a single superframe, n represents the number of the industrial wireless node, Real_{i,j} represents a priority of data sent by a j-th node in an i-th time slot of the next superframe in an actual measurement, Forecast_{i,j} represents a priority of data sent by the j-th node in the i-th time slot of the next superframe in the prediction, and Percent_{i,j} represents a probability of the j-th node sending data in the i-th time slot of the next superframe in the prediction.

Validation is performed based on a predetermined validation set by using a k-fold cross validation algorithm.

Performance test is performed on the model as below.

In the test, the model is tested based on each of data sets in the training set. An error value is obtained in each test. Based on all error values, an average error is calculated by using the following formula (5), which may be used to evaluate the predictive error performance of the model.

$$\overline{E} = \frac{{\sum }_{k = 1}^{q} {E}_{k}}{q} \qquad ( 5 )$$

where Ē represents the average error, q represents the number of the data sets in the testing set, and Eₖ represents an error obtained by testing the model with a k-th data set in the training set.

Then, the average error of the model is compared with a reference value. The reference value is related to the priorities of all the collected data packets, represents an average priority of data packets in the operation of the heterogeneous network, and may be used to determine whether the model is qualified. The reference value is calculated by using the following formula (6):

$$\overline{Goal} = \frac{\frac{1}{2} {\sum }_{k = 1}^{p} {\sum }_{i = 1}^{m} {\sum }_{{j = 1}^{}}^{n} {Real}_{k , i , j}^{2}}{k} \qquad ( 6 )$$

where G̅o̅a̅l̅ represents the reference value, p represents the total number of the data sets, m represents the number of the time slots in the single superframe, n represents the number of the industrial wireless nodes, and Real_{k,i,j} represents a priority of data sent by a j-th node in an i-th time slot of a k-th data set in the actual measurement.

A rule for comparing the average error of the model and the reference value is expressed in the following formula (7), which is used to determine whether the model is qualified:

$$\begin{matrix}\begin{matrix}0 \leq \overline{E} < \overline{Goal} * 1 \% , & qualified\end{matrix} \\ \begin{matrix}\overline{Goal} * 1 \% \leq \overline{E} \leq \overline{Goal} * 100 \% , & not qualified\end{matrix}\end{matrix} \qquad ( 7 )$$

where Ē represents the average error, and G̅o̅a̅l̅ represents the reference value.

The user performs comparison by using the above formula (7). In a case that the model is not qualified, the training is continued. In a case that the model is qualified, an average of network transmission delay predicted by the model is calculated by using the following formulas (8) and (9):

$$\overline{{T}_{idle}} = \frac{{\sum }_{k = 1}^{p} {\sum }_{i = 1}^{m} {T}_{slot}}{p} \qquad ( 8 )$$

where T̅_̅{̅i̅d̅l̅e̅}̅ represents an average time period of an idle time slot in the single superframe, p represents the total number of the data sets, m represents the number of the idle time slots in the single superframe, and Tₛₗₒₜ represents the same meaning as in formula 3;

$$\overline{delay} = ( 1 - \frac{\overline{E}}{\overline{Goal}} * {T}_{s l o t} ) + ( \frac{\overline{E}}{\overline{Goal}} * ( 1 - \frac{\overline{{T}_{idle}}}{{T}_{superframe}} ) * \frac{{T}_{superframe}}{\overline{{T}_{idle}}} * {T}_{s l o t} ) \qquad ( 9 )$$

where d̅e̅l̅a̅y̅ represents an average delay, Ē represents the same meaning as in formula 5, G̅o̅a̅l̅ represents the same meaning as in formula 6, Tₛₗₒₜ represents the same meaning as in formula 3, T_{superframe} represents the same meaning as in formula 2, and T̅_̅{̅i̅d̅l̅e̅}̅ represents the same meaning as in formula 8.

A rule for comparing the average network transmission delay and a required average delay is expressed in the following formula (10), which is used to determine whether the average network transmission delay predicted by the model is qualified:

$$\begin{matrix}\begin{matrix}0 \leq \overline{delay} \leq {delay}_{require} , & qualified\end{matrix} \\ \begin{matrix}\overline{delay} > {delay}_{require} , & not qualified\end{matrix}\end{matrix} \qquad ( 10 )$$

where d̅e̅l̅a̅y̅ represents the same meaning as in formula 8, and delay_{require} represents the required average delay inputted by the user.

The user performs comparison by using the above formula (10). In a case that the model is not qualified, the training is continued. In a case that the model is qualified, the training is ended and the online stage is entered.

In the online stage, the following three steps are performed.

In a first step, a heterogeneous network is configured.

The user configures a collaborative scheduling subsystem, an industrial wireless gateway, a wireless routing device and an industrial wireless node based on configuration information determined in the offline phase, which includes the following operations.

(1) The collaborative scheduling subsystem is configured with the time period of the superframe, the time period of the time slot, a network path information table, and the time slot requirement prediction model.

(2) All industrial wireless gateways, wireless routing devices, and industrial wireless nodes in the industrial wireless network are configured with the time period of the superframe, the time period of the time slot, and the network path information table.

In a second step, time slot prediction, time slot assignment, and beacon broadcasting are performed.

After a current superframe ends and before a next superframe starts, data packet information (where the structure of the data packet information is shown in Table 4) of the current superframe is inputted to the prediction model. The prediction model outputs time slot requirement prediction (where the structure of the time slot requirement prediction is shown in Table 5) for the next superframe. Based on the prediction information outputted by the prediction model, time slots are assigned sequentially.

A node with a probability greater than thresholdₚₑᵣ of transmitting data in a time slot is determined and is assigned with this time slot, and a node with a probability less than thresholdₚₑᵣ of transmitting data in a time slot is not assigned with this time slot. A time slot assignment result is written in a time slot assignment table as shown in the following Table 6:

| Time slot number | Nodes assigned with this time slot |
|---|---|
| 1 | IWNN_{1, 2, 1} |
| 2 | IWNN_{1, 1, 2}, IWNN_{2, 2, 2} |
| . . . | . . . |
| n | IWNN_{1, 1, 2} |

After the time slots are assigned, the time slot assignment table is written in a beacon frame. The beacon frame is broadcasted to all industrial wireless nodes in the industrial wireless network during beacon broadcasting, to update the time slot assignment table in all the industrial wireless nodes. In the next superframe, the industrial wireless nodes communicate with each other based on the updated time slot assignment table.

In a third step, data transmission is performed.

After performing time slot prediction, time slot assignment and beacon broadcasting, data is transmitted. A path is assigned for transmitting the data based on specific situations. The data to be transmitted includes: command data sent by the user and data sent by a node.

For the command data sent by the user, no time slot is assigned because sending a command by the user is an irregular behavior and is not predicted by the model. However, the command data sent by the user belongs to a command frame having a highest priority, so that the command data is directly transmitted through a shortest path selected from paths in the network.

For the data sent by the node, wireless routing devices records occupancy situations of all paths from the respective wireless routing devices to all other nodes (excluding the nodes of the respective wireless routing devices) and to the ISDC, into the path occupancy table as shown in the following Table 7:

TABLE 7

| Path | Destination | | Path | Priority of data |
|---|---|---|---|---|
| number | node | Detailed path | length | occupying the path |
| 1 | IWNN_{2, 1, 1} | IWNR_{1, 1} _{→} IWNS₁ _{→} TSNᵢ _{→} | 5 | 2, 3 |
| | | IWNS₂ _{→} IWNR_{2, 1} _{→} IWNN_{2, 1, 1} | | |
| 2 | IWNN_{2, 1, 2} | IWNR_{1, 1} _{→} IWNS₁ _{→} TSNᵢ _{→} | 5 | 2 |
| | | IWNS₂ _{→} IWNR_{2, 1} _{→} IWNN_{2, 1, 2} | | |
| . . . | . . . | . . . | . . . | . . . |
| n | ISDC | IWNR_{i, j} _{→} IWNSᵢ _{→} TSNᵢ _{→} ISDC | 4 | 3 |

A first line in Table 7 is taken as an example to illustrate the meaning of the data in the path occupancy table. The first line indicates a current path with a path number of 1. The destination node of this path is a first node mounted on a first router in a second industrial wireless network. The detailed path is expressed as IWNR_{1,1}→IWNS₁→TSNᵢ→IWNS₂→IWNR_{2,1}→IWNN_{2,1,1}. The path length is 5. The path is currently occupied by two pieces of data, and the priorities of the two pieces of data are respectively 2 and 3.

The path occupancy table is initialized in configuring the heterogeneous network in the online stage. Each wireless routing device selects all the paths from the respective wireless routing device to the other nodes (excluding the node of the respective wireless routing device) and to the ISDC based on the configured network path information table, fills in a destination node column based on the network path information table, and fills a priority of data occupying the path with 0.

The column of “priority of data occupying the path” in the path occupancy table is filled with 0 at a beginning of a superframe, and is updated every time when a path is occupied for sending data in a data transmission stage.

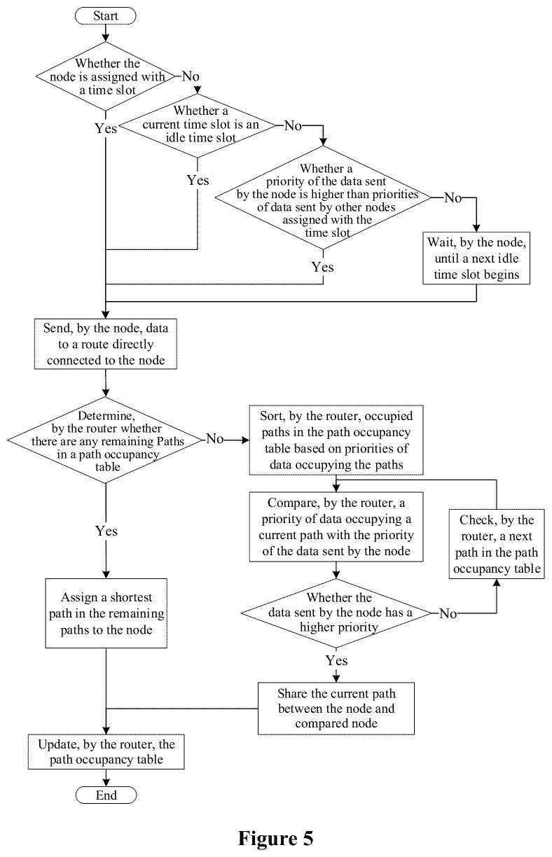

Many facts needs to be considered in path assignment performed when a node need to send data, as shown in FIG. 5. The following steps 1 to 5 are performed.

In step 1, it is determined whether the node sending the data is assigned with a time slot. In a case that the node sending the data is assigned with a time slot, the method proceeds to step 2; and in a case that the node sending the data is not assigned with a time slot, it is determined whether a current time slot is an idle time slot. In a case that the current time slot is an idle time slot, the method proceeds to step 2; and in a case that the current time slot is not an idle time slot, it is determined whether a priority of the data sent by the node is higher than priorities of data sent by other nodes assigned with the time slot. In a case that the priority of the data sent by the node is higher than the priorities of the data sent by the other nodes assigned with the time slot, the method proceeds to step 2; and in a case that the priority of the data sent by the node is not higher than the priorities of the data sent by the other nodes assigned with the time slot, the node waits until a next idle time slot begins.

In step 2, the node send data to a route directly connected to the node.

In step 3, the router determines whether there are any remaining paths in a path occupancy table. In a case that there are remaining paths in the path occupancy table, the router assigns a shortest path among the remaining paths to the node, updates the path occupancy table, and transmits the data. In a case that there are no remaining paths in the path occupancy table, the method proceeds to step 4.

In step 4, the router sorts the occupied paths in the path occupancy table based on priorities of data occupying the paths.

In step 5, the router compares a priority of data occupying a current path with the priority of the data sent by the node. In a case that the priority of the data sent by the node is higher than the priority of the data occupying the current path, the current path is shared between the node and compared node, the router updates the path occupancy table, and transmits the data. In a case that the priority of the data sent by the node is not higher than the priority of the data occupying the current path, the router checks a next path in the path occupancy table, and the method proceeds to step 4.

After a path is successfully assigned, the data is transmitted. After data sent by a node reaches an industrial wireless gateway of the industrial wireless network, the industrial wireless gateway sends the transmission information of the data to the ISDC collaborative scheduling subsystem. The ISDC collaborative scheduling subsystem adds the transmission information to the information table as shown in Table 5, to be used as an input for the LSTM neural network prediction model for the next superframe.

Finally, it should be noted that the above embodiments are only used to illustrate rather than limit the technical solutions of the present disclosure. Although the technical solutions have been described in detail with reference to the preferred embodiments, those skilled in the art should understand that modifications or equivalent substitutions may be made to the technical solutions of the present disclosure without departing from the principle and scope of the technical solutions of the present disclosure. All the modifications and equivalent substitutions to the present disclosure fall within the protection scope of the present disclosure.

1. A successive approximation-based joint scheduling method for a time sensitive network and an industrial wireless network, comprising:
in an offline stage:
S1: customizing a superframe structure in the industrial wireless network, obtaining, from a user, a time period of the superframe and a time period of a time slot, and calculating the number of the time slot;
S2: obtaining, from the user, data packet information sent by a node, wherein the data packet information is continuous over time;
S3: obtaining, from the user, a training set and a testing set for a time slot requirement prediction model; and
S4: training the time slot requirement prediction model; and
in an online stage:
S5: configuring a heterogeneous network, wherein a collaborative scheduling subsystem, an industrial wireless gateway, a wireless routing device and an industrial wireless node are configured with configuration information determined in the offline phase;
S6: performing time slot prediction, time slot assignment, and beacon broadcasting; and
S7: each of nodes in the industrial wireless network transmits data through an assigned path.

2. The successive approximation-based joint scheduling method for a time sensitive network and an industrial wireless network according to claim 1, wherein
the customizing a superframe structure in S1 comprises a beacon broadcasting stage and a data transmission stage;
in the beacon broadcasting stage, the collaborative scheduling subsystem predicts time slot requirements of nodes in a next superframe by using the time slot requirement prediction model and assigns time slots of the next superframe based on a prediction result, and then the industrial wireless gateway broadcasts a beacon frame to the industrial wireless network, wherein the beacon frame comprises a time slot assignment table of the next superframe; and
in the data transmission stage, the time slots are classified based on the time slot assignment table comprised in the beacon frame, the time slots are classified into periodic data time slots, non-periodic data time slots, and idle time slots, the periodic data time slots are assigned to a node required to upload periodic data, the non-periodic data time slots are assigned to a node determined by the time slot requirement prediction model that is required to upload non-periodic data, and the idle time slots are all other time slots than the periodic data slots and the non-periodic data slots.

3. The successive approximation-based joint scheduling method for a time sensitive network and an industrial wireless network according to claim 1, wherein
the time period of the superframe in S1 is determined by:
obtaining, from the user, service requirements of an industrial site to determine nodes required to upload periodic data, obtaining, from the user, time periods of the nodes uploading data, and determining the time period of the superframe as a least common multiple of the time periods by using the following equation:
$${T}_{superframe} = l c m ( {T}_{1} , {T}_{2} , … , {T}_{n} )$$
where T_{superframe} represents the time period of the superframe, T₁, T₂, . . . , Tₙ represent time periods required by respective n nodes to upload periodic data, and lcm represents the least common multiple; and
the time period of the time slot is determined by:
calculating the time period of the time slot based on lengths of paths in the network by using the following equation, wherein the time period of the time slot is positively correlated with a length of a longest path in the network:
$${T}_{slot} = ( max ( {Length}_{1} , {Length}_{2} , … , {Length}_{n} ) + 2 ) * {T}_{h o p}$$
where Tₛₗₒₜ represents the time period of the time slot, Length₁, Length₂, . . . , Lengthₙ represent lengths of respective n paths in the network, max represents a maximum value operation, and Tₕₒₚ represents an average time period required for a data packet to pass through a hop.

4. The successive approximation-based joint scheduling method for a time sensitive network and an industrial wireless network according to claim 1, wherein the constructing a training set and a testing set in S3 comprises:
S31: extracting data sets, wherein all collected data packets are extract into superframes, information of data packets in each of the superframes form a data set, a difference between a timestamp of the first data packet in a data set and a timestamp of the first data packet in a subsequent data set is equal to the time period of the superframe, and a front-closed and back-open interval between the timestamp of the first data packet in the data set and the timestamp of the first data packet in the subsequent data set are extracted to a data set;
S32: supplementing information in the data sets, wherein missed information for a plurality of time slots in the data sets is supplemented, information in a single data set is a m*n matrix, m represents the number of time slots in a single superframe, n represents the number of industrial wireless nodes in a heterogeneous network, each element in the matrix has a numerical value that represents a priority of data sent by an industrial wireless node in a time slot of a current superframe, and in the data set information matrix, 0 is filled for idle time slots to indicate that no node sends data in the idle time slots; and
S33: grouping the data sets, wherein for data sets with a scale of millions or less, 60% of the data sets are grouped to training sets, 20% of the data sets are grouped to validation sets, and 20% of the data sets are grouped to testing sets; and for data sets with a scale of millions or more, 98% of the data sets are grouped to training sets, 1% of the data sets are grouped to validation sets, and 1% of the data sets are grouped to testing sets.

5. The successive approximation-based joint scheduling method for a time sensitive network and an industrial wireless network according to claim 1, wherein the training the time slot requirement prediction model in S4 comprises:
inputting an m*n matrix from the training set;
outputting an m*n matrix, wherein each of elements in the matrix comprises a numerical value and a percentage, the numerical value represents a priority of data sent by an industrial wireless node in a time slot of a next superframe predicted by the model, and the percentage represents a probability of the node sending data in the time slot;
performing error calculation by using the following equation:
$$E = \frac{1}{2} {\sum }_{i = 1}^{m} {\sum }_{j = 1}^{n} {( {Real}_{i , j} - {Forecast}_{i , j} * {Percent}_{i , j} )}^{2}$$
where E represents an error of a prediction, m represents the number of time slots in a single superframe, n represents the number of the industrial wireless node, Real_{i,j} represents a priority of data sent by a j-th node in an i-th time slot of the next superframe in an actual measurement, Forecast_{i,j} represents a priority of data sent by the j-th node in the i-th time slot of the next superframe in the prediction, and Percent_{i,j} represents a probability of the j-th node sending data in the i-th time slot of the next superframe in the prediction;
performing validation based on a predetermined validation set by using a k-fold cross validation algorithm;
performing performance analysis on the model, wherein the model is tested using data sets in a training set to obtain error values, and an average error is obtained by using the following equation:
$$\overline{E} = \frac{{\sum }_{k = 1}^{q} {E}_{k}}{q}$$
where Ē represents the average error, q represents the number of the data sets in the testing set, and Eₖ represents an error obtained by testing the model with a k-th data set in the training set;
calculating an error reference value by using the following equation:
$$\overline{Goal} = \frac{\frac{1}{2} {\sum }_{k = 1}^{p} {\sum }_{i = 1}^{m} {\sum }_{j = 1}^{n} {Real}_{k , i , j}^{2}}{k}$$
where G̅o̅a̅l̅ represents the error reference value, p represents the total number of the data sets, m represents the number of the time slots in the single superframe, n represents the number of the industrial wireless nodes, and Real_{k,i,j} represents a priority of data sent by a j-th node in an i-th time slot of a k-th data set in actual measurement;
comparing the average error value with the error reference value by using the following formulas to determine whether the model is qualified:
$$\begin{matrix}\begin{matrix}0 \leq \overline{E} < \overline{Goal} * 1 \% , & qualified\end{matrix} \\ \begin{matrix}\overline{Goal} * 1 \% \leq \overline{E} \leq \overline{Goal} * 100 \% , & not qualified\end{matrix}\end{matrix}$$
continuing the training in a case that the model is not qualified; and
calculating an average network transmission delay predicted by the model using the following equation in a case that the model is qualified:
$$\overline{{T}_{idle}} = \frac{{\sum }_{k = 1}^{p} {\sum }_{i = 1}^{m} {T}_{slot}}{p}$$
where T̅_̅{̅i̅d̅l̅e̅}̅ represents an average time period of an idle time slot in the single superframe, p represents the total number of the data sets, m represents the number of the idle time slots in the single superframe, and Tₛₗₒₜ represents the time period of the time slot;
$$\overline{delay} = ( 1 - \frac{\overline{E}}{\overline{Goal}} * {T}_{s l o t} ) + ( \frac{\overline{E}}{\overline{Goal}} * ( 1 - \frac{\overline{{T}_{idle}}}{{T}_{superframe}} ) * \frac{{T}_{superframe}}{\overline{{T}_{idle}}} * {T}_{s l o t} )$$
where d̅e̅l̅a̅y̅ represents an average delay, and T_{superframe} represents the time period of the superframe;
wherein the average network transmission delay and a required average delay is compared by using the following formulas to determine whether the average network transmission delay predicted by the model is qualified, the training is continued in the case that the model is not qualified, and the training is ended and the online stage is entered in the case that the model is qualified:
$$\begin{matrix}\begin{matrix}0 \leq \overline{delay} \leq {delay}_{require} , & qualified\end{matrix} \\ \begin{matrix}\overline{delay} > {delay}_{require} , & not qualified\end{matrix}\end{matrix}$$
where delay_{require} represents the required average delay inputted by the user.

6. The successive approximation-based joint scheduling method for a time sensitive network and an industrial wireless network according to claim 1, wherein S5 comprises:
configuring the collaborative scheduling subsystem with the time period of the superframe, the time period of the time slot, a network path information table, and the time slot requirement prediction model, and
configuring all industrial wireless gateways, wireless routing devices, and industrial wireless nodes in the industrial wireless network with the time period of the superframe, the time period of the time slot, and the network path information table.

7. The successive approximation-based joint scheduling method for a time sensitive network and an industrial wireless network according to claim 1, wherein S6 comprises:
inputting, by the collaborative scheduling subsystem after a current superframe ends and before a next superframe starts, data packet information of the current superframe to the time slot requirement prediction model to output time slot requirement prediction information for the next superframe, and
assigning time slots sequentially, wherein a node with a probability greater than thresholdₚₑᵣ of transmitting data in a time slot is assigned with the time slot, a node with a probability less than thresholdₚₑᵣ of transmitting data in a time slot is not assigned with the time slot, wherein time slot assignment results are written in a time slot assignment table; and
writing, by the industrial wireless gateway after the time slots are assigned, the time slot assignment table in a beacon frame, and broadcasting the beacon frame to all industrial wireless nodes in the industrial wireless network, to update the time slot assignment table in all the industrial wireless nodes, wherein in the next superframe, the industrial wireless nodes communicates with each other based on the updated time slot assignment table.

8. The successive approximation-based joint scheduling method for a time sensitive network and an industrial wireless network according to claim 1, wherein
the data transmitted in step S7 comprises command data sent by the user and data sent by a node;
the command data sent by the user is not assigned with a time slot but has a highest priority, and is directly transmitted through a shortest path selected from paths in the network; and
the data sent by the node is transmitted by:
S71: determining, by a router, whether the node sending the data is assigned with a time slot;
in a case that the node sending the data is assigned with a time slot, proceeding to S72; and
in a case that the node sending the data is not assigned with a time slot, determining whether a current time slot is an idle time slot;
in a case that the current time slot is an idle time slot, proceeding to S72; and
in a case that the current time slot is not an idle time slot, determining whether a priority of the data sent by the node is higher than priorities of data sent by other nodes assigned with the time slot;
in a case that the priority of the data sent by the node is higher than the priorities of the data sent by the other nodes assigned with the time slot, proceeding to S72; and
in a case that the priority of the data sent by the node is not higher than the priorities of the data sent by the other nodes assigned with the time slot, the node waits until a next idle time slot begins;
S72: sending, by the node, data to a route directly connected to the node;
S73: determining, by the router whether there are any remaining paths in a path occupancy table;
in a case that there are remaining paths in the path occupancy table, assigning a shortest path in the remaining paths to the node, updating the path occupancy table, and transmitting the data; and
in a case that there are no remaining paths in the path occupancy table, proceeding to S74;
S74: sorting, by the router, occupied paths in the path occupancy table based on priorities of data occupying the paths;
S75: comparing, by the router, a priority of first data occupying a first path with the priority of the data sent by the node;
in a case that the priority of the data sent by the node is higher than the priority of the first data occupying the first path, sharing the first path between the data sent by the node and the first data, updating, by the router, the path occupancy table, and transmitting the data; and
in a case that the priority of the data sent by the node is not higher than the priority of the first data occupying the first path, checking, by the router, another path in the path occupancy table, and proceeding to S74; and
S76: transmitting the data after a path is successfully assigned, wherein after data sent by the node reaches an industrial wireless gateway of the industrial wireless network, the industrial wireless gateway sends the transmission information of the data to the collaborative scheduling subsystem, and the collaborative scheduling subsystem adds the transmission information to a data set to be used as an input to the time slot requirement prediction model for a next superframe.

9. The successive approximation-based joint scheduling method for a time sensitive network and an industrial wireless network according to claim 1, wherein
the path occupancy table is used by the wireless routing device to record occupancy situations of all paths from the wireless routing device to the other nodes and an industrial software defined controller;
the path occupancy table comprises a number of a path, a destination node of the path, details of the path, a length of the path, a quantity and a priority of data occupying the path;
the path occupancy table is initialized in configuring the heterogeneous network in the online stage; the wireless routing device selects all the paths from the wireless routing device to the nodes and the industrial software defined controller based on a configured network path information table, fills in a destination node column based on the network path information table, and fills a priority of data occupying the path with 0; and a column of priority of data occupying the path in the path occupancy table is filled with 0 at a beginning of a superframe, and is updated every time when a path is occupied for sending data in a data transmission stage.
